(19) United States
(12) Patent Application Publication
(10) Pub. No.: US 2013/0205799 A1
(43) Pub. Date: Aug. 15, 2013

(54) Outer Fuel Nozzle Inlet Flow Conditioner Interface to End Cap

(71) Applicants: Donald Mark Bailey, Greenville, SC (US); Abdul Rafey Khan, Greenville, SC (US); Robert Joseph Rohrssen, Greenville, SC (US); Mohan Krishna Bobba, Greenville, SC (US)

(72) Inventors: Donald Mark Bailey, Greenville, SC (US); Abdul Rafey Khan, Greenville, SC (US); Robert Joseph Rohrssen, Greenville, SC (US); Mohan Krishna Bobba, Greenville, SC (US)

(21) Appl. No.: 13/397,218

(22) Filed: Feb. 15, 2012

(51) Int. Cl. F02C 6/04

(52) U.S. Cl. 60/785

(57) ABSTRACT

An interface between an inlet flow conditioner and a compressor discharge air passage in a gas turbine includes a cap back plate including a curved exterior surface, and an inlet flow conditioner (IFC) cooperable with the cap back plate. An end of the IFC includes a curved exterior surface that is continued from the curved exterior surface of the cap back plate. The interface provides for more uniform and higher pressure air as well as more air supply, resulting in more uniform combustion.

### BACKGROUND OF THE INVENTION

The invention relates generally to gas turbines and, more particularly, to an interface between an inlet flow conditioner and a compressor discharge air passage in a gas turbine.

Gas turbine engines typically include a compressor for compressing an incoming airflow. The airflow is mixed with fuel and ignited in a combustor for generating hot combustion gases. The combustion gases in turn flow to a turbine. The turbine extracts energy from the gases for driving a shaft. The shaft powers the compressor and generally another element such as an electrical generator.

Cold air from a flow sleeve enters into the combustor headend region and is distributed among a plurality of nozzles. Generally, air passes through an inlet flow conditioner (IFC) and becomes uniform in circumferential direction. Subsequently, it is rotated by axially placed vanes, and fuel is injected into the flow through holes in the vanes for premixing of fuel and air.

In existing designs, the end cap to fuel nozzle IFC interface does not make a seamless transition. The step or cavity recess allows for substantial flow turning disturbances and losses to impact the uniformity of the flow turning into the fuel nozzle IFC. It would be desirable to smooth the flow of headend air to minimize pressure losses, avoid flow trips and reduce flow field disturbances.

### BRIEF DESCRIPTION OF THE INVENTION

In an exemplary embodiment, a compressor discharge air passage in a gas turbine includes a cap baffle positioned radially inward of the forward casing, where the cap baffle and forward casing define an upstream passage for compressor discharge air. A cap back plate is disposed at an end of the cap baffle and includes a curved exterior surface to facilitate turning the compressor discharge air. An inlet flow conditioner (IFC) is cooperable with the cap back plate and is positioned and shaped to direct the compressor discharge air toward a swirler inlet. An end of the IFC includes a curved exterior surface that is continued from the curved exterior surface of the cap back plate.

In another exemplary embodiment, a gas turbine includes a forward casing coupled with a compressor discharge casing, an end cover coupled with the forward casing, a plurality of fuel nozzles coupled with the end cover, and the compressor discharge air passage including the cap baffle, the cap back plate, and the IFC cooperable with the cap back plate.

In yet another exemplary embodiment, an interface between an inlet flow conditioner and a compressor discharge air passage in a gas turbine includes a cap back plate including a curved exterior surface, and an IFC cooperable with the cap back plate, where an end of the IFC includes a curved exterior surface that is continued from the curved exterior surface of the cap back plate.

### BRIEF DESCRIPTION OF THE DRAWINGS

FIG. 1 is a simplified schematic of a gas turbine; and

FIG. 2 is a cross-section through the forward case and compressor discharge air passage.

### DETAILED DESCRIPTION OF THE INVENTION

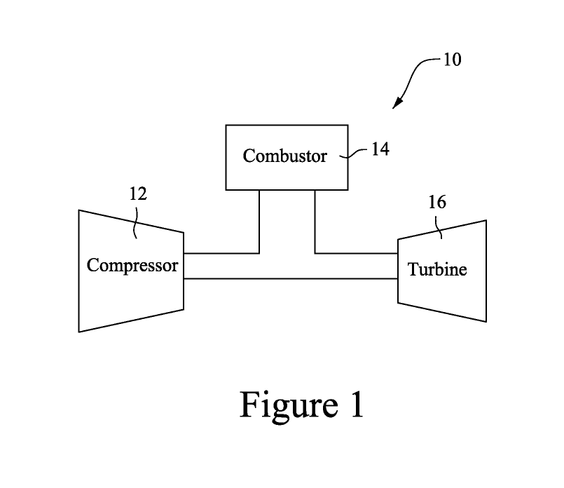

FIG. 1 illustrates a typical gas turbine 10. As shown, the gas turbine 10 generally includes a compressor at the front, one or more combustors 14 around the middle, and a turbine 16 at the rear. The compressor 12 and the turbine 16 typically share a common rotor. Typically, the compressor 12 pressurizes inlet air, which is then turned in direction or reverse flowed to the combustors 14 where it is used to cool the combustor and also to provide air to the combustion process. The combustors 14 inject fuel into the flow of compressed working fluid and ignite the mixture to produce combustion gases having a high temperature, pressure and velocity. The combustion gases exit the combustors 14 and flow to the turbine 16 where they expand to produce work.

A casing surrounds each combustor 14 to contain the compressed working fluid from the compressor 12. Nozzles are arranged in an end cover, for example, with outer nozzles radially arranged around a center nozzle. The compressed working fluid from the compressor 12 flows between the casing and a liner to the outer and center nozzles, which mix fuel with the compressed working fluid, and the mixture flows from the outer and center nozzles into upstream and downstream chambers where combustion occurs.

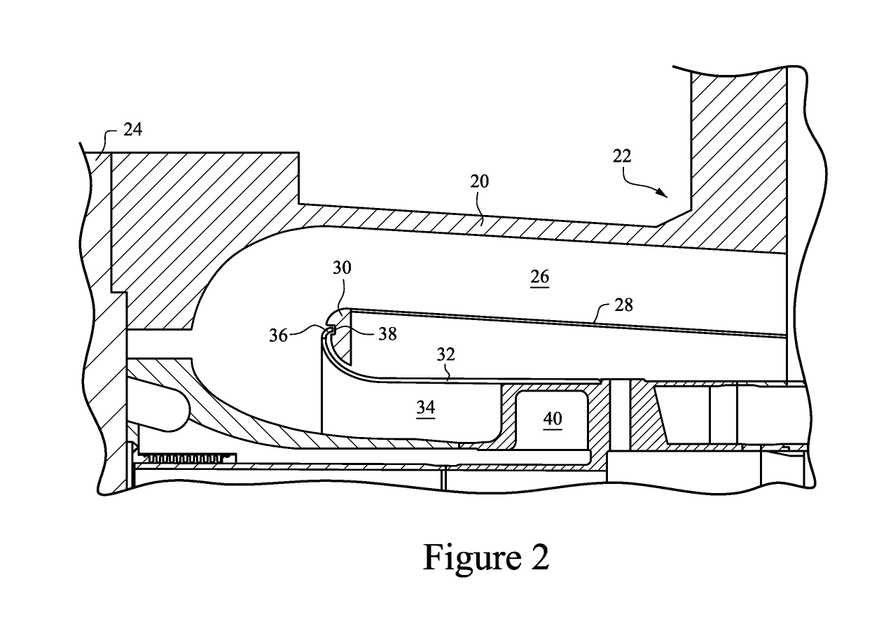

FIG. 2 is a cross-section through a combustor forward case 20 adjacent one of the outer annular nozzles. The forward case 20 is coupled with a compressor discharge casing 22 at a forward end and an end cover 24 at a back end. The combustor fuel nozzles are coupled with the end cover 24.

An upstream air passage 26 is defined by a cap baffle 28 positioned radially inward of the forward casing 20. In a conventional construction, headend compressor discharge air is directed via the upstream passage 26 to the end cover 24. The head end air is turned approximately 180° and is directed into the fuel nozzle to be mixed with fuel for downstream combustion. With existing designs, the cap baffle includes a curved end or tip to facilitate turning the headend air toward the fuel nozzle. Existing designs, however, allow for substantial flow turning disturbances and losses, which adversely impact the uniformity of the flow turning into the fuel nozzle.

The compressor discharge air passage shown in FIG. 2 endeavors to provide a seamless transition that also allows for positional variation of the IFC to the cap baffle. A cap back plate 30 is disposed at an end of the cap baffle 28. As shown, the cap back plate 30 includes a curved exterior surface, which facilitates turning the compressor discharge air. An inlet flow conditioner (IFC) 32 is cooperable with the cap back plate 30 and is positioned and shaped to direct the compressor discharge air toward a fuel nozzle inlet 34. As shown, an end of the IFC 32 includes a curved exterior surface that is essentially continued from the curved exterior surface of the cap back plate 30.

The upstream air passage 26 is an annular passage that provides inlet air for the fuel nozzles. The IFC 32 generally comprises a bell mouthed cylindrical component that extends annularly across the annularly-arranged outer nozzles.

Preferably, the IFC 32 is coupled with the cap back plate 30 via a tongue and groove connection or the like. That is, the end 36 of the IFC 32 is engageable with a corresponding slot or groove 38 in the cap back plate 30. Preferably, the slot 38 is sized to accommodate stack up variations of gas turbine components. The slot 38 is also sized to accommodate variations in IFC height and position.

As shown, the IFC 32 is connected between the cap back plate 30 and the fuel nozzle inlet 34 (swirler inlet). FIG. 2 also shows a swirler 40 upstream of the IFC 32.

By providing the interface between the upstream passage and the inlet flow conditioner, headend air flow can be smoothly turned to minimize pressure losses, avoid flow trips and minimize field disturbances. The structure results in added pressure and air supply as well as more uniform air supply into the fuel nozzle, resulting in more uniform combustion. This result is especially advantageous with quat fuel injection systems due to elevated flame holding risks.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A compressor discharge air passage in a gas turbine, wherein a forward casing is coupled with a compressor discharge casing, an end cover is coupled with the forward casing, and a plurality of fuel nozzles are coupled with the end cover, the compressor discharge air passage comprising:
a cap baffle positioned radially inward of the forward casing, the cap baffle and forward casing defining an upstream passage for compressor discharge air;
a cap back plate disposed at an end of the cap baffle, the cap back plate including a curved exterior surface to facilitate turning the compressor discharge air; and
an inlet flow conditioner (IFC) cooperable with the cap back plate and being positioned and shaped to direct the compressor discharge air toward a swirler inlet, an end of the IFC including a curved exterior surface that is continued from the curved exterior surface of the cap back plate.

2. A compressor discharge air passage according to claim 1, wherein the IFC is coupled with the cap back plate.

3. A compressor discharge air passage according to claim 2, wherein the cap back plate comprises a slot in the exterior surface, and wherein the end of the IFC is disposed in the slot.

4. A compressor discharge air passage according to claim 1, wherein the cap back plate comprises a slot in the exterior surface, and wherein the end of the IFC is disposed in the slot.

5. A compressor discharge air passage according to claim 4, wherein the slot is sized to accommodate stack up variation of gas turbine components.

6. A compressor discharge air passage according to claim 5, wherein the slot is sized to accommodate variations in IFC height and position.

7. A compressor discharge air passage according to claim 1, wherein the IFC is connected between the cap back plate and the swirler inlet.

8. A compressor discharge air passage according to claim 1, wherein the upstream air passage is an annular passage, and wherein the cap back plate and the IFC extend annularly around the annular air passage.

9. A compressor discharge air passage according to claim 8, wherein the IFC comprises a bell mouth shape from the inlet flow conditioner to the cap back plate.

10. A gas turbine comprising:
a forward casing coupled with a compressor discharge casing;
an end cover coupled with the forward casing;
a plurality of fuel nozzles coupled with the end cover; and
a compressor discharge air passage including:
a cap baffle positioned radially inward of the forward casing, the cap baffle and forward casing defining an upstream passage for compressor discharge air,
a cap back plate disposed at an end of the cap baffle, the cap back plate including a curved exterior surface to facilitate turning the compressor discharge air, and
an inlet flow conditioner (IFC) cooperable with the cap back plate and being positioned and shaped to direct the compressor discharge air toward a swirler inlet, an end of the IFC including a curved exterior surface that is continued from the curved exterior surface of the cap back plate.

11. A gas turbine air passage according to claim 10, wherein the IFC is coupled with the cap back plate.

12. A gas turbine air passage according to claim 11, wherein the cap back plate comprises a slot in the exterior surface, and wherein the end of the IFC is disposed in the slot.

13. A gas turbine air passage according to claim 10, wherein the IFC is connected between the cap back plate and the swirler inlet.

14. A gas turbine air passage according to claim 10, wherein the upstream air passage is an annular passage, and wherein the cap back plate and the IFC extend annularly around the annular air passage.

15. A gas turbine air passage according to claim 14, wherein the IFC comprises a bell mouth shape from the inlet flow conditioner to the cap back plate.

16. An interface between an inlet flow conditioner and a compressor discharge air passage in a gas turbine, the interface comprising:
a cap back plate including a curved exterior surface; and
an inlet flow conditioner (IFC) cooperable with the cap back plate, an end of the IFC including a curved exterior surface that is continued from the curved exterior surface of the cap back plate.

17. An interface according to claim 16, wherein the IFC is coupled with the cap back plate.

18. An interface according to claim 17, wherein the cap back plate comprises a slot in the exterior surface, and wherein the end of the IFC is disposed in the slot.

19. An interface according to claim 16, wherein the cap back plate comprises a slot in the exterior surface, and wherein the end of the IFC is disposed in the slot.
